(19) United States
(12) Patent Application Publication
(10) Pub. No.: US 2005/0202362 A1
(43) Pub. Date: Sep. 15, 2005

(54) Mirror shade guide for dental whitening

(76) Inventors: Calvin D. Ostler, Riverton, UT (US); Robert K. Larsen, Sandy, UT (US)

Correspondence Address: Parsons Behle & Latimer, 201South Main Street, Suite 1800, P. O. Box 45898, Salt Lake City, UT, 84111, US

(21) Appl. No.: 10/945,249

(22) Filed: Sep. 20, 2004

Related U.S. Application Data
(63) Continuation-in-part of application No. 10/797,628, filed on Mar. 10, 2004.

(51) Int. Cl. A61C 19/10; A61C 3/00

(52) U.S. Cl. 433/26; 433/31

(57) ABSTRACT

A mirror shade guide for use in dental whitening. A mirror and dental shade guide are combined for a patient to compare his or her teeth to prior to, during, and/or after a dental whitening regimen.

### PRIORITY

This patent application is a continuation-in-part of U.S. patent application Ser. No. 10/797,628 filed on Mar. 10, 2004, which is hereby incorporated by reference.

### BACKGROUND

In the field of dental whitening, it would be useful to have a dental shade guide which is convenient for a dental patient to use. For example, a dental patient whitening his or her teeth at home may wish to consult a dental shade guide prior to commencement of whitening treatment, and periodically thereafter, in order to gauge his or her progress.

### SUMMARY

Various mirror shade guide configurations are described.

### BRIEF DESCRIPTION OF DRAWINGS

FIGS. 1-4 depict various mirror shade guides.

FIG. 5 depicts a dental whitening kit that includes a mirror shade guide.

### DETAILED DESCRIPTION

When a dental patient chooses to undergo tooth whitening, whether through a procedure provided by a dentist in a dental office or whether through a home dental whitening regimen, the patient will often wish to have a means for verifying progress of the whitening procedure. This is especially critical for the more expensive whitening procedures provided by dentists in their offices.

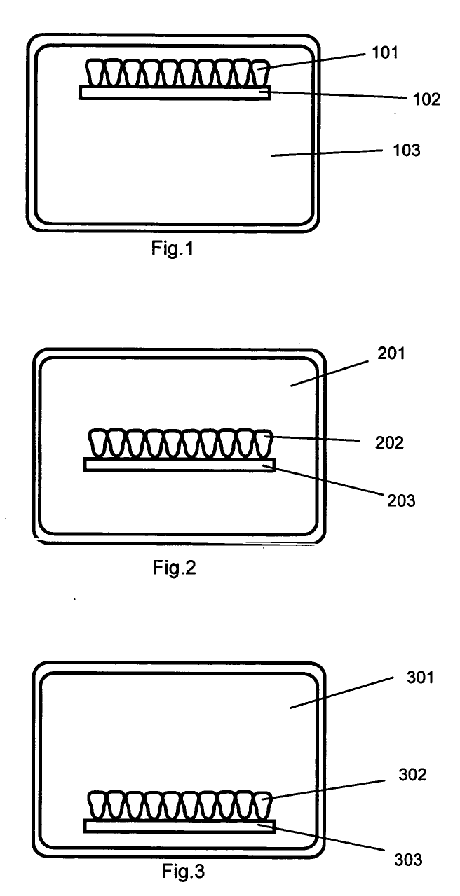

FIG. 1 depicts an example mirror shade guide that includes a mirror 103 in which a dental patient may view his or her own teeth. On or next to the mirror, a plurality of example dental shades 102 is provided. Each individual dental shade 101 may replicate as close as possible, an actual human dental shade. By comparing his or her own teeth to the example shades, a dental patient can ascertain a starting point for a whitening regimen. Later, after the regimen is completed or has progressed, the dental patient may use the mirror shade guide to ascertain progress.

The dental shades used may be a full scale of shades and colors, such as 32 different shades. Or a reduced set of shades may be provided such as 10 shades or 16 shades. Each shade block (such as 101) may be in any desired shape, such as a circle, oval, square, rectangle, tooth-shaped or otherwise. As an alternative, the dental shades may be provided as a continuum with a scale for marking the location of the patient's dental shade on the continuum.

In FIG. 1, the dental shades are placed on the upper portion of a mirror above the location where a dental patient's teeth will appear reflected in the mirror. FIG. 2 depicts a similar mirror shade guide to that of FIG. 1 but which has a mirror 201 with a shade guide 203 that has dental shades 202 centrally located on the mirror so that the patient's teeth may appear above or below the dental shades in the mirror. FIG. 3 depicts a mirror shade guide with a mirror 301 having located on it a dental shade guide 303 with dental shades 302 placed on the mirror in a location below where a reflection of a patient's teeth will appear in the mirror. Location of the dental shade guide is a matter of preference and may include any location on the mirror, along the top of the mirror, along the bottom of the mirror, to either side of the mirror, or elsewhere. The mirror may be any desired shape such as round, oval, square, rectangular or otherwise. The mirror may be any reflective surface, including an actual mirror or any other surface in which a patient may view an image or his or her teeth. The dental shade guide may be placed actually on the mirror, within the mirror or adjacent the mirror. Alternatively, the dental shade guide may be in the form of a sticker, magnet or other configuration which allows the patient to place the dental shade guide onto a desired reflective surface, such as on his or her own mirror at home.

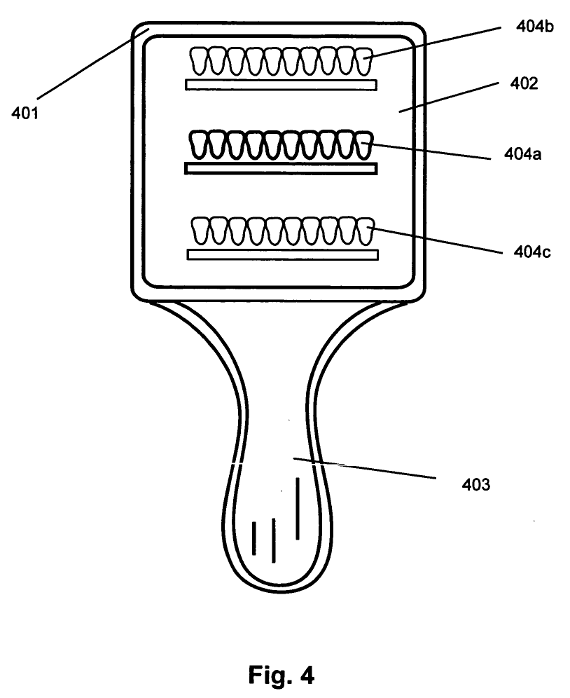

FIG. 4 depicts an alternative mirror shade guide 401 which includes a handle 403 for a dental patient to grasp while viewing his or her teeth. In addition, three rows of dental shade guides 404a, 404b and 404c are provided on a mirror 402. This configuration permits 3 different tooth colors to be represented as well as a variety of dental shades.

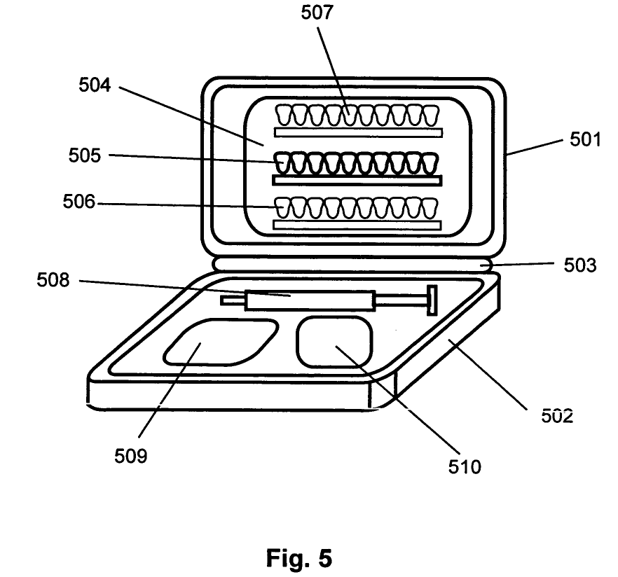

FIG. 5 depicts a dental whitening kit. The kit includes a container that has a folding top half 501, a hinge 502, and a bottom half 502. The top and bottom halves may be folded together at the time of sale and for transport, but may be opened from each other by pivoting with respect to the hinge. A mirror shade guide is provided on the upper half 501, the mirror shade guide including a mirror 504, and three dental shade guides 505, 506 and 507. The dental whitening kit also includes a quantity of dental whitener 508 and may include applicator means such as a dental whitening tray 510 into which dental whitener may be dispensed and then applied to teeth, and a carrying case 509 for the dental whitening tray. The dental whitener 508 may be contained in any desired fashion, such as a tube or syringe. If desired, a twin compartment or two component dental whitener may be used, such as those dispensed from a double barrel syringe. A dental whitener would contain a whitening agent such as a peroxide and be capable of releasing oxygen ions to remove stains from teeth. If a two part dental whitener is used, then in addition to a whitening agent, the dental whitener may include as a second component an accelerator or energizer which accelerates or increases the release of oxygen ions in order to accelerate or intensify the dental whitening process. The energizing or accelerating process may be achieved by the energizer or accelerator chemically reacting with the whitening agent (which contains oxygen) to cause a rapid release of oxygen from the whitening agent. Example whitening agents include hydrogen peroxide and carbamide peroxide. Example energizers include potassium hydroxide, potassium iodide, iodine and potassium. A basic substance may be added to the energizer to further enhance the release of oxygen from the whitening agent. A two part dental whitener may be dispensed, for example, from a double barrel syringe so that the whitening agent and the energizer contact each other only momentarily before being applied to teeth. Application to teeth may be accomplished by using a brush, a dental tray, or other means for contacting the whitener to the teeth so that oxygen ions will remove stains from the teeth.

As an example, teeth may be whitened by the following method. First, dental patient compares his or her teeth to a dental shade guide. The patient may attempt to match both tooth color and shade on the shade guide and note the same for future reference. Second, a patient undergoes a tooth whitening regiment. Third, the patient consults a dental shade guide again and notes the difference where his or her teeth score after the dental whitening regimen as compared to before the dental whitening regimen. The process of consulting a dental shade guide includes obtaining a mirror shade guide which has a dental shade guide on or adjacent a mirror, observing a reflection of the patient's teeth in the mirror and comparing them against the shades and/or colors of the dental shade guide, and noting the closest match.

While apparatuses, compositions and methods have been described and illustrated in conjunction with a number of specific ingredients, materials and configurations herein, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations of snacks described herein are to be considered in all respects as only illustrative, and not restrictive. All changes which come within the meaning and range of equivalency of the claims are to be embraced within their scope.

1. A dental whitening kit comprising:
a container,
a mirror shade guide, and
dental whitener.

2. A dental whitener kit as recited in claim 1 wherein said mirror shade guide includes a mirror capable of reflecting an image of a patient's teeth, and a dental shade guide for comparing color or shade of a patient's teeth to colors or shade on said dental shade guide.

3. A dental whitener kit as recited in claim 2 wherein said dental shade guide is located on said mirror.

4. A dental whitener kit as recited in claim 2 wherein said dental shade guide is located adjacent said mirror.

5. A dental whitener kit as recited in claim 2 wherein said dental shade guide includes a continuum of dental shades.

6. A dental whitener kit as recited in claim 2 wherein said dental shade guide includes more than one row of dental shades or colors.

7. A dental whitener kit as recited in claim 2 wherein said whitener includes a whitening agent that has oxygen within it.

8. A dental whitener kit as recited in claim 7 wherein said dental whitener whitens by said whitening agent releasing oxygen ions which bond to and remove organic stain molecules from teeth.

9. A dental whitener kit as recited in claim 8 wherein said dental whitener also includes an energizer.

10. A dental whitener kit as recited in claim 9 wherein said energizer chemically reacts with said dental whitener to accelerate or intensity release of oxygen ions from said whitening agent.

11. A method for a dental patient to whiten his or her teeth outside of a dentist's office comprising the steps of:
obtaining a mirror shade guide that includes
a mirror capable of reflecting an image of a dental patient's teeth, and
a dental shade guide for comparing color or shade of a patient's teeth to colors or shades on said dental shade guide,
making a comparison of color or shade of said dental patient's teeth to said colors or shade on dental shade guide,
obtaining a dental whitener,
exposing said dental patient's teeth to said dental whitener, and
utilizing said mirror shade guide to note progress of whitening of said dental patient's teeth.

12. A method as recited in claim 11 wherein said dental shade guide is located on said mirror.

13. A method as recited in claim 11 wherein said dental shade guide is located adjacent said mirror.

14. A method as recited in claim 11 wherein said dental shade guide includes a continuum of dental shades.

15. A method as recited in claim 11 wherein said dental shade guide includes more than one row of dental shades or colors.

16. A method as recited in claim 11 wherein said whitener includes a whitening agent that has oxygen within it.

17. A method as recited in claim 16 wherein said dental whitener whitens said patient's by said whitening agent releasing oxygen ions which bond to and remove organic stain molecules from teeth.

18. A method as recited in claim 17 wherein said dental whitener also includes an energizer.

19. A method as recited in claim 18 wherein said energizer chemically reacts with said dental whitener to accelerate or intensity release of oxygen ions from said whitening agent in order to accelerate whitening of said dental patient's teeth.
